(19) United States
(12) Patent Application Publication
(10) Pub. No.: US 2011/0022718 A1
(43) Pub. Date: Jan. 27, 2011

(54) Data Deduplication Apparatus and Method for Storing Data Received in a Data Stream From a Data Store

(76) Inventors: Nigel Ronald Evans, Bristol (GB); Russell Ian Monk, Caldicot (GB); Garry Brady, Bristol (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/841,898

(22) Filed: Jul. 22, 2010

(30) Foreign Application Priority Data
Jul. 24, 2009 (GB) 0912846.3

(51) Int. Cl. G06F 15/16

(52) U.S. Cl. 709/231

(57) ABSTRACT

A method of storing data received in a data stream from a data source is disclosed in which prior to performing deduplication on the data stream a processor decompresses selected compressed data entities in the data stream to provide a decompressed form of the data entities in the data stream in place of the compressed form, the data stream including the decompressed data entities is deduplicated and the deduplicated data is stored to a deduplicated data store.

### PRIORITY CLAIM

This application claims priority to foreign patent application no. GB 0912846.3, filed 24 Jul. 2009. This application is hereby incorporated by reference as though fully set forth herein.

### BACKGROUND

In storage technology, deduplication is a process in which data is analysed to identify duplicate portions in the data. One of the identified portions can then be stored using a small footprint data identifier, such as a hash, with a locator for the stored duplicate data, instead of duplicating the identified portion in data storage. In this manner, with certain types of data, it is possible to increase the amount of data stored using a given storage capacity.

### BRIEF DESCRIPTION OF THE DRAWINGS

In order that the invention may be well understood, by way of example only, various embodiments thereof will now be described with reference to the accompanying drawings, in which:

FIG. 1 is a schematic illustration of a data deduplication apparatus including an encoded entity handler;

FIG. 2 shows a portion of the apparatus of FIG. 1 in greater detail;

FIGS. 3a to 3c illustrate stages in the processing of portions of a data stream;

FIG. 4 illustrates a method of storing data from a data stream to a deduplicated data store; and

FIG. 5 illustrates flows of data when writing and reading data using the apparatus of FIG. 1.

### DETAILED DESCRIPTION

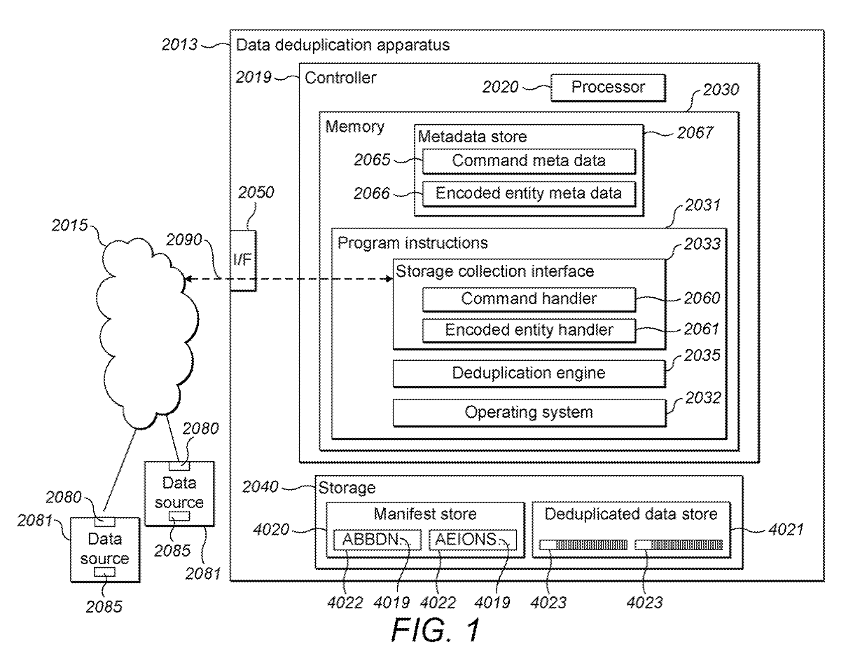

Referring to FIG. 1, a data deduplication apparatus 2013 comprises data processing apparatus in the form of a controller 2019 having a processor 2020 and a computer readable medium 2030 in the form of a memory. The memory 2030 can comprise, for example, RAM, such as DRAM, and/or ROM, and/or any other convenient form of fast direct access memory. During use of the data deduplication apparatus 2013, the memory 2030 has stored thereon computer program instructions 2031 executable on the processor 2020, including an operating system 2032 comprising, for example, a Linux, UNIX or OS-X based operating system, Microsoft Windows operating system, or any other suitable operating system. The data deduplication apparatus 2013 also includes at least one communications interface 2050 for communicating with at least one external data source 2081, for example over a network 2015. The or each data source 2081 can comprise a computer system such as a host server or other suitable computer system, executing a storage application program, for example a backup application such as Data Protector available from Hewlett-Packard Company.

The data deduplication apparatus 2013 also includes secondary storage 2040. The secondary storage 2040 may provide slower access speeds than the memory 2030, and conveniently comprises hard disk drives, or any other convenient form of mass storage. The hardware of the exemplary data deduplication apparatus 2013 can, for example, be based on an industry-standard server. The secondary storage 2040 can be located in an enclosure together with the data processing apparatus 2020, 2030, or separately.

A link can be formed between the communications interface 2050 and a host communications interface 2080 over the network 2015, for example comprising a Gigabit Ethernet LAN or any other suitable technology. The communications interface 2050 can comprise, for example, a host bus adapter (HBA) using iSCSI over Ethernet or Fibre Channel protocols for handling backup data in a tape data storage format, a NIC using NFS or CIFS network file system protocols for handling backup data in a NAS file system data storage format, or any other convenient type of interface.

The program instructions 2031 also include modules that, when executed by the processor 2020, respectively provide at least one storage collection interface, in the form, for example, of a virtual tape library (VTL) interface 2033 and/or NAS interface (not shown), and a data deduplication engine 2035, as described in further detail below.

The virtual tape library (VTL) interface 2033 in the example is to emulate at least one physical tape library, facilitating that existing storage applications, designed to interact with physical tape libraries, can communicate with the interface 2033 without significant adaptation, and that personnel managing host data backups can maintain current procedures after a physical tape library is changed for a VTL. A communications path can be established between a storage application and the VTL interface 2033 using the interfaces 2050, 2080 and the network 2015. A part 2090 of the communications path between the VTL interface 2033 and the network 2015 is illustrated in FIG. 1.

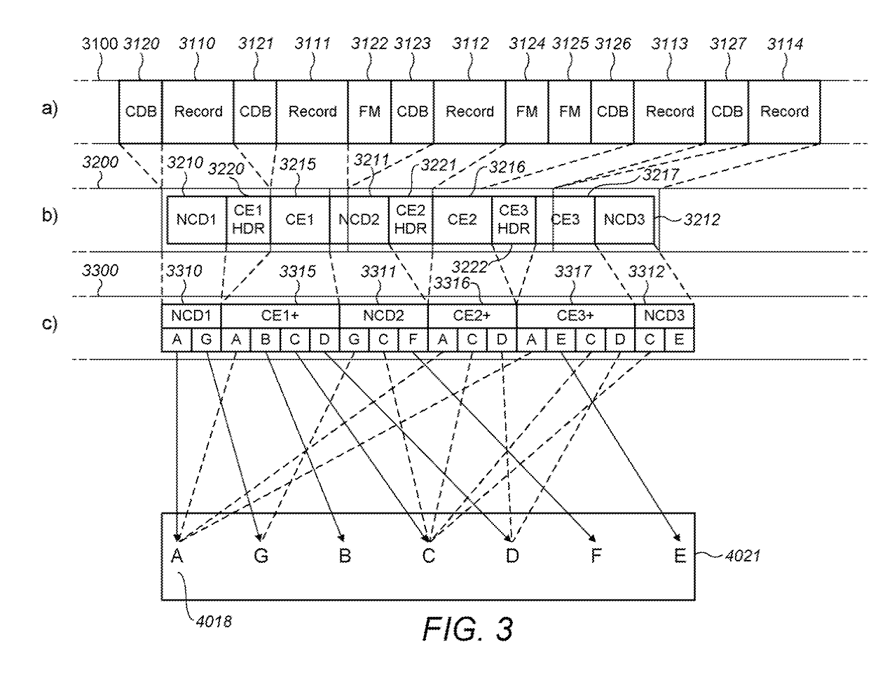

The VTL interface 2033 can receive a stream of data 3100 as shown in FIG. 3a, including records 3110 to 3114 and commands 3120 to 3127 in a tape data storage format from a host storage application 2085 storage session, for example a backup session, and provide services as would a physical tape library. For example, as shown in FIG. 3a, the data stream 3100 comprises SCSI command set commands such as write commands 3120, 3121, 3123, 3126, 3127 provided in command descriptor blocks (CDBs) in a SCSI command phase, the write commands being associated with respective records 3110 to 3114 provided in respective immediately subsequent data phases. File marks 3122, 3124, 3125 can also be provided in CDBs, for subsequent use by the storage application. The VTL interface 2033 is responsive to the write commands 3120, 3121, 3123, 3126, 3127 to write the records 3110 to 3114 to a virtual tape cartridge. The VTL interface 2033 is also responsive to read commands (not shown) contained in CDBs to read data back to a data source 2081, and also to other tape storage application commands, including other SCSI command set commands. Data such as the write commands and file marks 3120 to 3127 received in a command phase is referred to herein as command meta data, and is distinct from the record data received in a data phase.

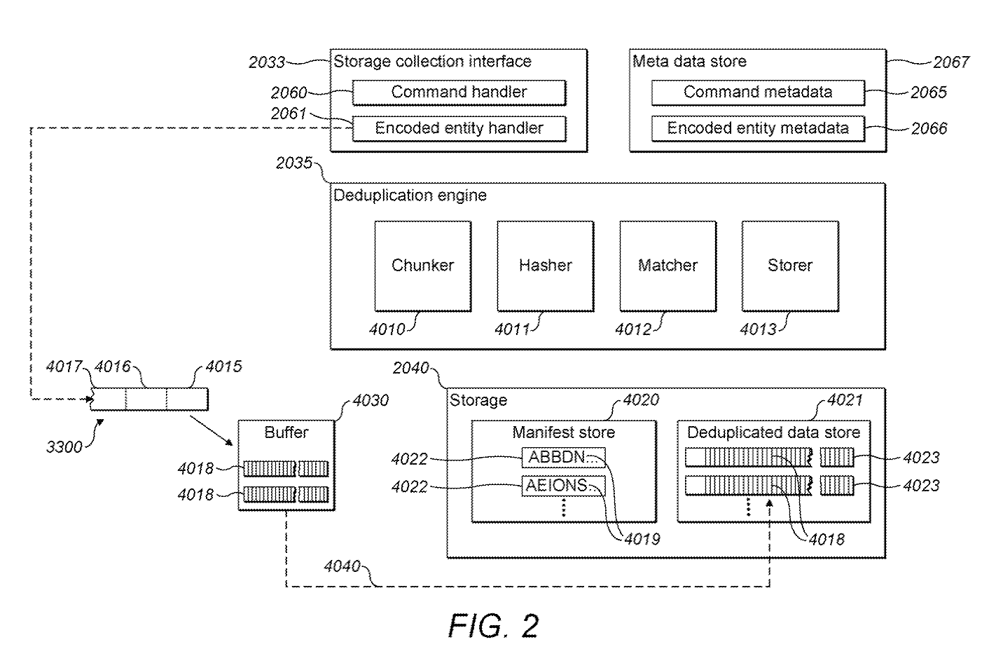

Referring to FIG. 2, the VTL interface 2033 comprises a command handler 2060, for handling commands placed in the data stream by a data source 2081. In response to receiving write commands, for example, in CDBs 3120, 3121, 3123, 3126, 3127, in addition to initiating write operations, the command handler 2060 is operable to identify and remove the CDBs 3120 to 3127 comprising command meta data, including file mark CDBs 3122, 3124, 3125, from the data stream 3100 to provide a stripped data stream 3200 (FIG. 3b) containing the record data 3110 to 3114. The stripped command meta data 2065 is stored in a meta data store 2067 for future retrieval, for example during read operations.

The NAS interface, if provided, presents a file system to the host storage application. A NAS backup file can, for example, comprise a relatively large backup session file provided as a data stream by a backup application 2085. Meta data relating to a typical NAS backup session file may be integrated in the backup session file or provided in one or more separate files. In some embodiments, the command meta data is not stripped from the data stream.

The stripped data stream 3200 (FIG. 3b) contains the record data, comprising non-encoded data entities and encoded data entities. For example, in the embodiment shown in FIG. 3b, the encoded data entities 3215, 3216, 3217 are compressed data entities, and the non-encoded data entities are non-compressed data entities 3210, 3211, 3212. Each encoded data entity 3215, 3216, 3217 is associated with respective meta data 3220, 3221, 3222 in the data stream, the meta data 3220, 3221, 3222 relating to an encoding process that has been used to encode the encoded data entity 3215, 3216, 3217. For example, each compressed data entity 3215 (CE1), 3216 (CE2), 3217 (CE3) is immediately preceded in the data stream by respective meta data, in the form of a header 3220 (CE1 header), 3221 (CE2 header), 3222 (CE3 header) associated with the compressed data entity. As seen in FIG. 3b, non-compressed entities 3210, 3211, 3212 and compressed entities 3215, 3216, 3217 can extend across record boundaries.

The storage collection interface also comprises an encoded entity handler 2061. The encoded entity handler 2061 is operable to examine the stripped data stream 3200 and identify in the data stream 3200 meta data associated with an encoded data entity, the meta data relating to an encoding process that has been used to encode the data entity. For example, the encoded entity handler 2061 is provided with compression scheme recognition data that is associated with predetermined data compression schemes, enabling the encoded entity handler 2061 to recognise from header meta data 3220, 3221, 3222 a data compression scheme that has been applied to a respective compressed data entity 3215, 3216, 3217 disposed immediately subsequent to the header meta data in the data stream 3200. The compression scheme recognition data can relate to any desired data compression scheme.

In one example, the encoded entity handler 2061 includes compression scheme recognition data to identify files that have been encoded using a ZIP file format, the format specification for which is readily available. An example, is the ZIP file format specification version 6.3.2 published by PKWARE Inc. The structure of such a ZIP file, containing multiple files, file 1 banana.txt and file 2 apple.txt, that have been compressed into the ZIP file, takes the form:
[local file header 1]
[file data 1]
[local file header 2]
[file data 2]
[central directory]
   [file header 1]
   [file header 2]
[end of central directory record]

The [local file header 1] is structured as follows:

local file header signature 4 bytes (0x04034b50)
version needed to extract 2 bytes
general purpose bit flag 2 bytes
compression method 2 bytes
last mod file time 2 bytes
last mod file date 2 bytes
crc-32 4 bytes
compressed size 4 bytes
uncompressed size 4 bytes
file name length 2 bytes
extra field length 2 bytes

In this example, the compression scheme recognition data includes at least the four byte value 0x04034b50 representing a ZIP local file header signature. The encoded entity handler 2061 examines the sequence of bytes in the data stream 3200 and, if it encounters an apparent ZIP local file header signature, identifies the immediately following meta data as encoded data entity meta data. The encoded entity handler 2061 can also be operable to perform additional checks for expected value ranges in other expected fields in the identified ZIP local file header to prevent misdetection.

In response to confirmed identification of a ZIP encoded data entity, the identified ZIP file header meta data is used to decode the encoded data entity by decompressing the file data according to information contained in the respective ZIP file headers for each compressed file. For example, the [file header 1] in the [central directory] of the exemplary ZIP file can have the following structure:
central file header signature 4 bytes (0x02014b50)
version made by 2 bytes
version needed to extract 2 bytes
general purpose bit flag 2 bytes
compression method 2 bytes
to last mod file time 2 bytes
last mod file date 2 bytes
crc-32 4 bytes
compressed size 4 bytes
uncompressed size 4 bytes
file name length 2 bytes
extra field length 2 bytes
file comment length 2 bytes
disk number start 2 bytes
internal file attributes 2 bytes
external file attributes 4 bytes
relative offset of local header 4 bytes
file name (variable size) “banana.txt”
extra field (variable size)
file comment (variable size)

The encoded entity handler 2061 is operable to use, for example, the data in at least the [file header 1] fields “compression method”, “version needed to extract”, and “version made by” to decompress the [file data 1] encoded data. Other files, such as [file data 2], in the compressed data entity are also decompressed accordingly. The resulting data stream 3300 is shown in FIG. 3c, comprising the decompressed data entities 3315 (CE1+), 3316 (CE2+), 3317 (CE3+) and noncompressed data entities 3310, 3311, 3312. The VTL interface 2033 is operable to pass the partially decompressed data stream 3300 to the deduplication engine 2035 for further processing.

The decompressed file size can be compared to the expected uncompressed file size as specified in the headers as an additional check for correct ZIP file identification. Meta data contained in the [local file header], [file header] and [end of central directory record] files is stored as encoded entity meta data 2066 in the meta data store 2067. The data stream is processed in an in-line manner. The compressed and non-compressed data contained in the records is not stored to relatively slow secondary storage such as the storage 2040 prior to deduplication.

Although the command meta data 2065 and the encoded entity meta data 2066 are shown in one meta data store 2067, separate meta data stores could be provided. The meta data stores can be structured in any convenient manner, for example using a file system or database. Program instructions (not shown) for generating and operating the or each data store can conveniently be stored in the memory 2030.

As shown in FIG. 2, the deduplication engine 2035 includes functional modules comprising a chunker 4010, a chunk identifier generator in the form of a hasher 4011, a matcher 4012, and a storer 4013, as described in further detail below. The storage collection interface such as the VTL user interface 2033 and/or the NAS user interface can pass data to the deduplication engine 2035 for deduplication and storage. In one example, a data buffer 4030, for example a ring buffer, controlled by the deduplication engine 2035, receives the at least partially decompressed data stream 3300 from the VTL interface 2033. The data stream 3300 can conveniently be divided by the deduplication engine 2035 into data segments 4015, 4016, 4017 for processing. The segments 4015, 4016, 4017 can be relatively large, for example, many MBytes, or any other convenient size. The chunker 4010 examines data in the buffer 4030 and, using any convenient chunk selection process, generates data chunks 4018 of a convenient size for processing by the deduplication engine 2035. Data chunks 4018 are represented in FIG. 3c by letters A, B, C, D, E, F and G.

The hasher 4011 is operable to process a data chunk 4018 using a hash function that returns a number, or hash, that can be used as a chunk identifier 4019 to identify the chunk 4018. The chunk identifiers 4019 are stored in manifests 4022 in a manifest store 4020 in secondary storage 2040. Each manifest 4022 comprises a plurality of chunk identifiers 4019. The chunk identifiers 4019 are represented in FIGS. 1 and 2 by respective letters, identical letters denoting identical chunk identifiers 4019.

The matcher 4012 is operable to attempt to establish whether a data chunk 4018 in a newly arrived segment 4015 is identical to a previously processed and stored data chunk. This can be done in any convenient manner. If no match is found for a data chunk 4018 of a segment 4015, the storer 4013 will store the corresponding unmatched data chunk 4018 from the buffer 4030 to a deduplicated data store 4021 in secondary storage 2040, as shown by the unbroken arrows in FIG. 3c. If a match is found, the storer 4030 will not store the corresponding matched data chunk 4018, but will obtain, from meta data stored in association with the matching chunk identifier, a storage locator for the matching data chunk. The obtained locator meta data is stored in association with the newly matched chunk identifier 4019 in a manifest 4022 in the manifest store 4020 in secondary storage 2040, as indicated by broken connecting lines in FIG. 3c.

Because the compressed entities are presented to the deduplication engine 2035 in decoded form, there can be a significantly increased probability of obtaining a larger number of matching data chunks 4018 during the matching process in many data storage situations, for example multiple sequential data backup sessions. For example, as shown in FIG. 3c, the data chunks A in decompressed entities 3315, 3316 and 3317, and the data chunks C and D in decompressed entities 3316 and 3317 can be matched, and corresponding data chunks are not stored as duplicate data in the deduplicated data store 4021. This matching would almost certainly not have been available using the compressed entities 3215, 3216, 3217, because even a very small change in a pre-compression user record results in very major changes to a subsequent compressed entity.

Data chunks 4018 are conveniently stored in the deduplicated data store in relatively large containers 4023, having a size, for example, of say between 2 and 4 Mbytes, or any other convenient size. Data chunks 4018 can be processed to compress the data if desired prior to saving to the deduplicated data store 4021, for example using LZO or any other convenient compression algorithm. It will be appreciated that the skilled person will be able to envisage many alternative ways in which to store and match the chunk identifiers and data chunks. If the cost of an increase in size of fast access memory is not a practical impediment, at least part of the manifest store and/or the deduplicated data store could be retained in fast access memory.

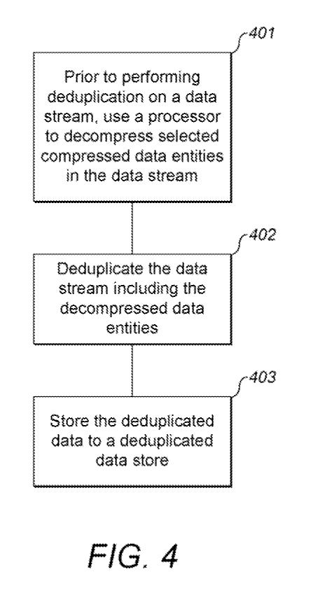

As shown in FIG. 4, using the deduplication apparatus 2013 described above, prior to performing deduplication on a data stream, a processor is used to decompress selected compressed data entities in the data stream (step 401). The data stream including the decompressed data entities is deduplicated (step 402) and the deduplicated data is stored to a deduplicated data store (step 403).

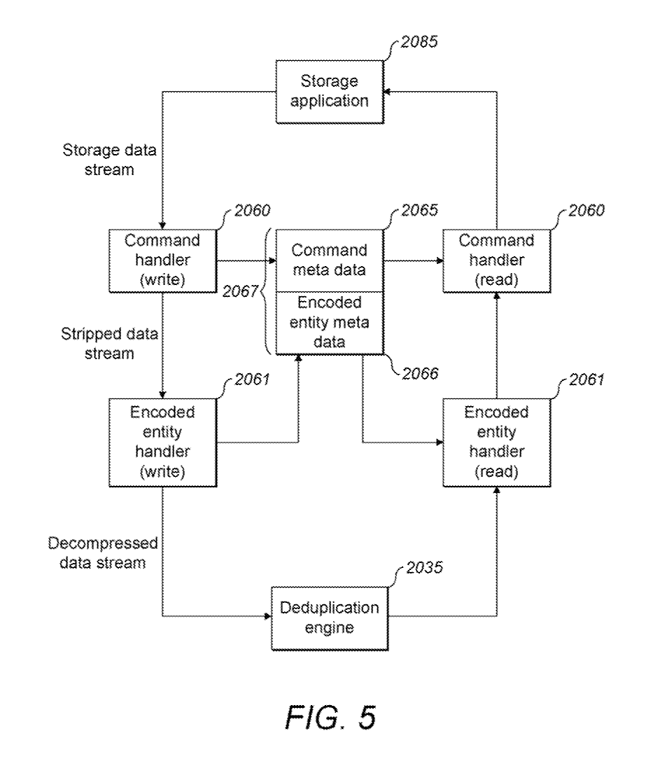

FIG. 5 shows the process in greater detail. A storage application 2085 causes a storage data stream, for example a data backup session in the form of a data stream 3100 as described above with reference to FIG. 3a, to be sent to the deduplication apparatus 2013. The command handler 2060 recognises a write command in the data stream and commences a write operation, removing command meta data from the data stream 3100 and storing the command meta data 2065 to the meta data store 2067. The stripped data stream 3200 with the command meta data removed is processed by the encoded entity handler 2061, which decodes encoded data entities 3215, 3216, 3217 identified in the data stream 3200 using meta data associated with the respective encoded data entities, removing the encoded entity meta data 2066 from the data stream 3200 and storing it to the meta data store 2067. The encoded entity handler 2061 re-inserts the decoded data entities 3315, 3316, 3317 into the data stream 3300. The data stream 3300 including the decoded data entities is processed by the deduplication engine 2035. Only unmatched data chunks in the data stream 3300 are written to the deduplicated data store 4021, whereas matched data chunks are stored as data identifiers 4019 in the manifest store 4020, each data identifier 4019 referencing a corresponding matched data chunk in the deduplicated data store 4021.

In response to the command handler 2060 receiving a read request, the de-duplication engine 2035 is instructed by the storage collection interface 2033 to reassemble the requested data, which will reassemble a portion of the decompressed data stream 3300. The encoded entity handler 2061 accesses the relevant encoded entity meta data 2066 from the meta data store 2067, and where appropriate assembles the resulting data into compressed entities with associated compressed entity headers, resulting in a data stream structured similarly to the data stream 3200 of FIG. 3b. This resulting data stream is processed by the command handler 2060, which reinserts relevant command meta data 2065 from the meta data store 2067 into the data stream. The storage collection interface 2033 causes the de-duplication apparatus 2013 to return the thus reconstructed data stream to the storage application 2085.

At least some of the embodiments described above provide a greater opportunity for the data deduplication engine to match data entities, or portions of data entities, which in the unencoded condition thereof have many identical chunks, but which lose that identity when even slightly changed and encoded as part of a storage data stream, for example a backup data stream. This facilitates, at least when used with certain types of data, a decrease in the volume of data required to be stored and a consequential increase in the amount of data that can be stored using a defined storage capacity.

There may be some residual level of duplication of data chunks in the deduplicated data store 4021, and the terms deduplication and deduplicated should be understood in this context. In alternative embodiments, other techniques of deduplication can be employed than as described above.

While various embodiments have been described above with reference to data entities encoded using data compression schemes, the invention also has application to data entities encoded using other types of data encoding schemes, for example data encryption schemes. In the example of data encryption schemes, an appropriate key management arrangement is necessary, for example to securely provide appropriate encryption and/or decryption keys to the data deduplication apparatus.

1. Data deduplication apparatus for storing data received in a data stream from a data source, the apparatus comprising;
an encoded entity handler operable to:
identify, in the data stream, meta data associated with an encoded data entity, the meta data relating to an encoding process that has been used to encode the encoded data entity;
use the meta data to decode the encoded data entity to provide a decoded form thereof; and
substitute said decoded form of the encoded data entity for the encoded form thereof in the data stream; and
a deduplication engine to:
perform deduplication on the data stream including at least one said decoded data entity to provided deduplicated data; and
store the deduplicated data to a deduplicated data store.

2. The data deduplication apparatus of claim 1, wherein said deduplicated data store comprises secondary storage.

3. The data deduplication apparatus of claim 1, wherein the meta data comprises header meta data according to a data compression scheme that has been used to encode the encoded data entity, the header meta data facilitating a decompression process by which the encoded entity handler decodes the encoded data entity.

4. The data deduplication apparatus of claim 1, wherein the encoded entity handler is further to remove the identified meta data from the data stream, and store the meta data in an encoded entity meta data store for access when required during a read operation.

5. The data deduplication apparatus of claim 1, further comprising a command handler to identify command meta data in the received data stream, remove the command meta data from the data stream, and store the command meta data in a command meta data store for access when required during a read operation.

6. The data deduplication apparatus of claim 5, wherein the command handler is to remove the command meta data from the data stream prior to processing of the data stream by the encoded entity handler.

7. The data deduplication apparatus of claim 5, wherein the received data stream is a tape data backup stream formatted according to a tape data format, and the command meta data comprises command descriptor blocks relating to records and file marks.

8. A method of storing data received in a data stream from a data source, the method comprising:
prior to performing deduplication on a data stream, using a processor to decompress selected compressed data entities in the data stream to provide a decompressed form thereof to replace of the compressed form thereof;
deduplicating the data stream including the decompressed data entities; and
storing the deduplicated data to a deduplicated data store.

9. The method of claim 8, wherein storing the deduplicated data to a data store comprises storing the deduplicated data to secondary storage.

10. The method of claim 8, further comprising removing meta data from the data stream, and storing the meta data to a meta data store for access when required during a read operation.

11. The method of claim 10, wherein the meta data comprises header meta data according to a data compression scheme that has been used to encode the data entity, the header meta data enabling the data deduplication apparatus to perform decompression to decode the data entity.

12. The method of claim 10, wherein the meta data comprises command meta data in the received data stream.

13. Data deduplication storage apparatus for in-line processing of data received in a data stream from a data source, the apparatus comprising:
an encoded entity handler to:
receive the data stream and identify meta data in the data stream that is indicative of recognised encoded data formats, the identified meta data being associated with encoded data in the data stream;
use the identified meta data to decode the associated encoded data and provide a decoded form of the data in the data stream in place of the encoded form thereof; and
remove the identified meta data from the data stream; and
a deduplication engine to:
receive the data stream downstream of the encoded data entity handler and perform deduplication on the data stream to provide deduplicated data; and
secondary storage in which said deduplicated data is stored.

14. The data deduplication apparatus of claim 13, wherein said encoded entity handler is to remove said meta data from the data stream to a meta data store.

15. The data deduplication apparatus of claim 13, further comprising a command handler to identify command data in the data stream upstream of said encoded entity handler and remove the identified command meta data from the data stream to a meta data store.

16. The data deduplication apparatus of claim 15, wherein the received data stream is a tape data backup stream formatted according to a tape data format, and the command meta data comprises command descriptor blocks relating to records and file marks.

17. The data deduplication apparatus of claim 13, further comprising a buffer that receives the data stream downstream of the encoded entity data handler, said deduplication engine comprising a module that divides the data in the buffer into segments that are analysed for duplication by the deduplication engine.
